(19) United States
(12) Patent Application Publication
(10) Pub. No.: US 2024/0252921 A1
(43) Pub. Date: Aug. 1, 2024

(54) GAME SYSTEM, STORAGE MEDIUM USED THEREIN, AND CONTROL METHOD

(71) Applicant: KONAMI AMUSEMENT CO., LTD., Ichinomiya-shi (JP)

(72) Inventors: Yoshihiro TAGAWA, Ichinomiya-shi (JP); Makoto ISHIHARA, Ichinomiya-shi (JP); Koki OGAWA, Ichinomiya-shi (JP); Rei TAKANO, Ichinomiya-shi (JP)

(73) Assignee: KONAMI AMUSEMENT CO., LTD., Ichinomiya-shi (JP)

(21) Appl. No.: 18/628,909

(22) Filed: Apr. 8, 2024

Related U.S. Application Data
(63) Continuation of application No. PCT/JP22/36791, filed on Sep. 30, 2022.

(30) Foreign Application Priority Data
Oct. 12, 2021 (JP) 2021-167275

(51) Int. Cl. A63F 13/5375; A63F 13/213; A63F 13/44; A63F 13/814

(52) U.S. Cl. CPC A63F 13/5375; A63F 13/44; A63F 13/814; A63F 13/213

(57) ABSTRACT

Provided is a game system capable of providing a user with information for assisting in perceiving the next action when the next action is a related action related to the previous action. A game machine is connected to a monitor that displays a guide screen on which sample images showing a series of actions constituting a dance are presented in order of the series of actions, and a camera that detects user's actions, and the game machine provides a dance game in which each action and execution time thereof is guided through a sample image and the actions of the user are evaluated. The game machine specifies one action and a next action on the basis of sequence data, and when the next action is a repeat action or a reverse action, which are related actions related to the one action, and displays a related type sample image including a repeat image or a reverse image on the guide screen, which are related information indicating relevance between the one action and the next action.

### BACKGROUND OF THE INVENTION

### Field of the Invention

The present invention relates to, for example, a game system connected to an output device including a display device that displays a game screen in which an action image showing each action of a series of actions that constitute a dance is presented in order of the series of actions and a detection device that detects user's actions, and providing a timing game that guides each action and execution time of each action through action images and evaluates user's actions.

### Description of the Related Art

There is known a game system connected to an output device including a display device that displays a game screen in which an action image showing each action of a series of actions that constitute a dance is presented in order of the series of actions and a detection device that detects user's actions, and provides a timing game that guides each action and execution time of each action through action images and evaluates user's actions (for example, see Non Patent Literature 1).

### CITATION LIST

### Non Patent Literature

Non Patent Literature 1: DanceCheesecake, “Dance Central 3—I Am the Best (Hard)—2NE1—*FLAWLESS*”, [online], [Searched on Sep. 6, 2021], Internet <URL: https://www.youtube.com/watch?app=desktop&v=zjLNN90yuv M>

### SUMMARY OF THE INVENTION

### Technical Problem

In the game of Non Patent Literature 1, actions (dance) to be executed every predetermined duration are continuously guided one by one through a panel-like model including a character that represents the actions (still image). In the game, even if the next action is an action that repeats the previous action, the action is similarly guided through the same model as the previous action. Therefore, a user has to play while checking all models one by one, and has to be conscious of perceiving the next action while executing the immediately preceding action. As a result, there is a possibility that the difficulty level of the game becomes unnecessarily high. The tendency is especially high when a fast-paced and continuous dance is required. In addition, there is also a possibility that the user is only focused on perceiving the next action, and will not be able to fully enjoy playing the game itself including various elements such as a dance of a character that appears in the game

Therefore, an object of the present invention is to provide, for example, a game system that can provide a user with information for assisting in perceiving the next action when the next action is a related action related to the previous action.

### Solution to Problem

A game system of the present invention is a game system comprising a computer connected to an output device including a display device that displays a game screen in which an action image showing each action of a series of actions that constitute a dance is presented in order of the series of actions and a detection device that detects a user's action, and providing a timing game that guides each action and execution time of each action through the action image and evaluates the user's action, wherein the compute serves as: an action specifying unit that specifies one action of the series of actions and a next action that follows the one action based on sequence data in which each action of the series of actions and the execution time to execute each action are described in association with each other; and an information providing unit that provides the user with related information indicating relevance between the one action and the next action through the output device when the next action is a related action to be executed based on the one action as an action related to the one action.

Meanwhile, non-transitory computer readable storage medium of the present invention is a non-transitory computer readable storage medium storing a computer program configured to cause a computer connected to the output device and the detection device to function as each unit of the game system described above.

In addition, a control method of the present invention is a control method executed by a computer incorporated in a game system that is connected to an output device including a display device that displays a game screen in which an action image showing each action of a series of actions that constitute a dance is presented in order of the series of actions and a detection device that detects a user's action, and provides a timing game that guides each action and execution time of each action through the action image and evaluates the user's action, wherein the control method comprises: an action specifying procedure that specifies one action of the series of actions and a next action that follows the one action based on sequence data in which each action of the series of actions and the execution time to execute each action are described in association with each other; and an information providing procedure that provides the user with related information indicating relevance between the one action and the next action through the output device when the next action is a related action to be executed based on the one action as an action related to the one action.

### BRIEF DESCRIPTION OF THE DRAWINGS

FIG. 1 is a diagram showing a schematic configuration of a game system according to one embodiment of the present invention.

FIG. 2 is a functional block diagram showing main parts of a control system of the game system.

FIG. 3 is a diagram schematically showing an example of a guide screen of a dance game.

FIG. 4 is a diagram schematically showing an example of a repeat type sample image.

FIG. 5 is a diagram schematically showing an example of a reverse type sample image.

FIG. 6 is a diagram showing an example of a configuration of sequence data.

FIG. 7 is a flowchart showing an example of a procedure for sequence processing.

FIG. 8 is a flowchart showing an example of a procedure for action evaluation processing.

### DESCRIPTION OF THE EMBODIMENTS

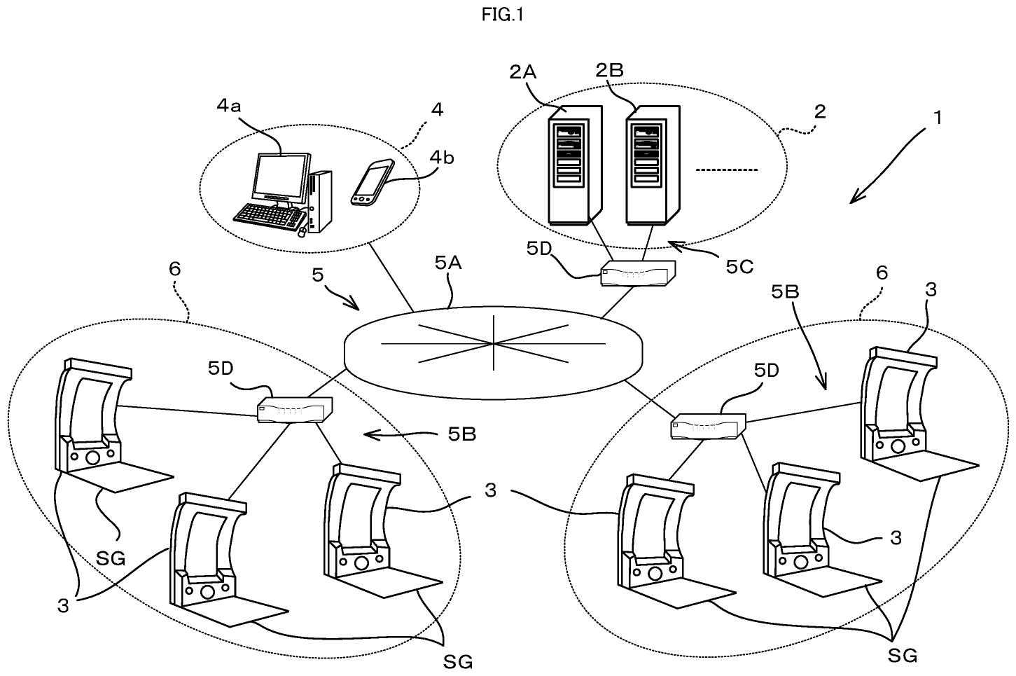

An example of a game system according to one embodiment of the present invention will be described below. First, with reference to FIG. 1, the overall configuration of the game system according to one embodiment of the present invention will be described. The game system 1 includes a center server 2 and a plurality of game machines 3 serving as client devices connectable to the center server 2 via a predetermined network 5. The center server 2 is configured as one logical server device by combining server units 2A, 2B . . . serving as a plurality of computer devices. However, the center server 2 may be configured by a single server unit. Alternatively, the center server 2 may be logically configured by using cloud computing.

The game machine 3 is an example of a game device that provides a game as a predetermined service. The game machine 3 may provide a game for free. As an example, the game machine 3 provides a game for pay. In addition, the game machine 3 may include various game devices (computer devices) that provide games, for example, if a user terminal device 4 described later provides a game, the game machine 3 may include such a user terminal device 4, and is configured as a game machine for commercial use (business use) as an example. The game machine for commercial use is a game device that allows a user to play a game within a range corresponding to a playing fee in exchange for payment of the predetermined playing fee. This kind of game machine 3 is sometimes called an arcade game machine. The game machine 3 may be installed at any appropriate location, and in the example of FIG. 1, the game machine 3 is installed at an appropriate facility 6 such as a store with the main purpose of increasing profits by having many users repeatedly play games.

The game machine 3 provides a timing game. The timing game is a type of game that guides and evaluates the execution time of a proper playing action. The timing game includes a music game, and the like that, for example, guides proper time of playing actions according to the rhythm of music, and the game machine 3 presents a dance game as one type of timing game. The dance game is a type of music game that requires a user to execute a series of actions that constitute a dance as playing actions. Specifically, in the dance game, a series of actions that constitute a dance and the execution time to execute each action are guided in accordance with the rhythm of the music piece, and the user's actual actions (dance) are evaluated based on the series of actions and the execution times.

The game machine 3 may be provided with, for example, various output devices as appropriate, and in the example of FIG. 1, a stage SG is provided. The stage SG functions as a range in which the user should perform a dance as a playing action. That is, the user plays the dance game on the stage SG. The stage SG may function as a detection device to detect a user's action such as step, but is used as an example to simply indicate the range for play. Incidentally, the stage SG may be omitted, or may be replaced as appropriate with another device such as a projector that displays the range corresponding to the stage SG.

The user terminal device 4 may be connected to the game system 1 via the network 5. The user terminal device 4 is a computer device that can be connected to a network and is provided for the user's personal use. As the user terminal device 4, various computer devices that can be connected to a network and are provided for the user's personal use may be used, such as a mobile game machine and a mobile tablet terminal device. In the example of FIG. 1, a mobile terminal device 4b is used, such as a stationary or book-type personal computer 4a, or a mobile phone (including smartphones). The user terminal device 4 can allow the user to enjoy diverse services provided by the center server 2 by implementing various type of computer software.

The network 5 may be configured as appropriate as long as the game machine 3 and the user terminal device 4 can be connected to the center server 2. As an example, the network 5 is configured to implement network communication by using a TCP/IP protocol. Typically, the network 5 is constructed by connecting the Internet 5A as a WAN and LANs 5B and 5C connecting each of the center server 2 and the game machine 3 to the Internet 5A via a router 5D. The user terminal device 4 is also connected to the Internet 5A with an appropriate configuration via an access point, for example. Incidentally, a local server may be installed between the game machine 3 and the router 5D of the facility 6, and the game machine 3 may be communicably connected to the center server 2 via the local server. The server units 2A, 2B, . . . of the center server 2 may be connected to each other by a WAN 5A instead of or in addition to the LAN 5C.

The center server 2 provides the game machine 3 or the user thereof with various game machine services related to the dance game. The game machine service may include various services related to the dance game. As an example, the game machine service includes a distribution service that distributes and updates programs or data via the network 5. Through such a distribution service, the center server 2 distributes various programs or data necessary to provide each game machine 3 with the dance game as appropriate, for example. Incidentally, in addition to the distribution service, the game machine service may also include a service to receive user identification information from the game machine 3 and authenticate the user. In addition, the game machine service may also include a service to receive data such as a usage history of the authenticated user from the game machine 3 and store the data, or provide the game machine 3 with the data to store. Furthermore, the game machine service may include, for example, a billing service to collect fees from users, a matching service to match with other users.

Similarly, the center server 2 provides the user of the user terminal device 4 with various Web services via the network 5. The Web service may include appropriate services. For example, the web service may include various services such as an information service that provides various pieces of information about games provided by the game machine 3, a distribution service that distributes various data or software (including update of data, and the like) to each user terminal device 4, a community service that provides a place for users to communicate, exchange, and share information, and a service that assigns a user ID for identifying each user.

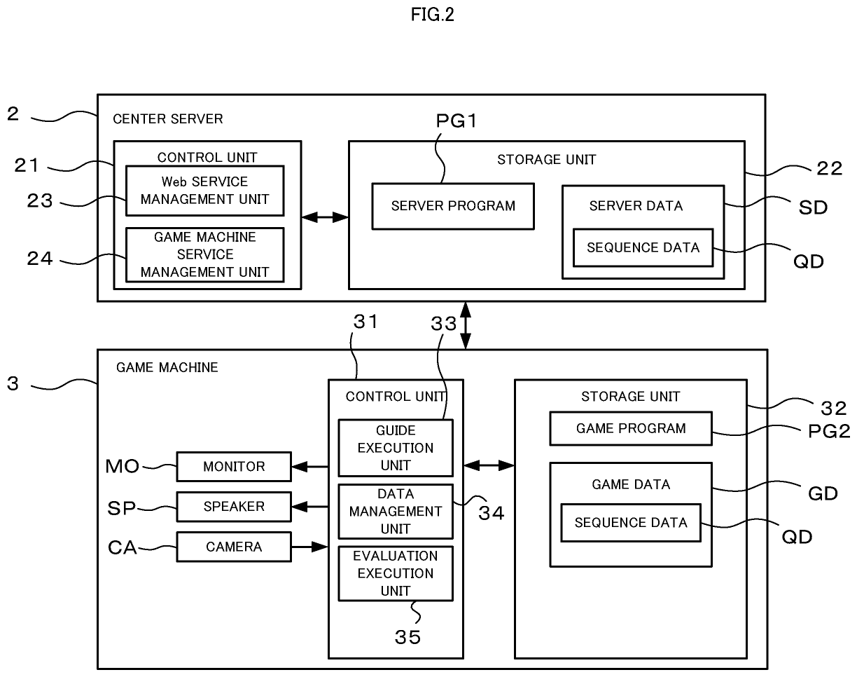

Next, the main parts of the control system of the game system 1 will be described with reference to FIG. 2. First, the center server 2 is provided with a control unit 21 and a storage unit 22 serving as a storage device. The control unit 21 is configured as a computer obtained by combining a CPU as an example of a processor that executes various arithmetic processes and action control according to a predetermined computer program, and peripheral devices such as an internal memory necessary for the action.

The storage unit 22 is an external storage device implemented by a storage unit including a non-volatile storage medium (computer-readable storage medium) such as a hard disk array. The storage unit 22 may be configured to keep all data in one storage unit, or may be configured to store data in a plurality of storage units in a distributed manner. The storage unit 22 records a server program PG1 as an example of a computer program that causes the control unit 21 to execute various processes necessary to provide the user with various services.

In addition, the storage unit 22 stores server data SD necessary to provide services such as a game machine service. Such server data SD includes various data, and in the example of FIG. 2, sequence data QD is shown as one type of such data. The sequence data QD is data that describes a series of actions that constitute a dance and the execution time to execute each action. The sequence data QD is used to guide such a series of actions and each execution time to the user. In addition, when a dance is actually performed by the user, the dance is evaluated based on the action and the execution time of the sequence data QD. That is, the sequence data QD is used to guide and evaluate each action. In the dance game, when a plurality of music pieces or a plurality of difficulty levels are prepared, the sequence data QD is prepared for each music piece or each difficulty level. Details of the sequence data QD will be further described later.

Incidentally, other than the above data, the server data may include, for example, various data for implementing various services. For example, such data may include play data that describes information regarding each user's past play performance, or ID management data for managing various ID such as user ID for identifying each user. In addition, the server data may include, for example, image data for displaying various images for a game screen, or music data for playing back a music piece for a game as game data. However, illustration thereof is omitted.

The control unit 21 is provided with a logical device implemented by combining a hardware resource of the control unit 21 and the server program PG1 as a software resource. An appropriate logical device can be provided as such a logical device, and the example of FIG. 2 shows a Web service management unit 23 and a game machine service management unit 24. The Web service management unit 23 is a logical device that executes various processes for implementing the above-mentioned Web service for the user terminal device 4. Similarly, the game machine service management unit 24 is a logical device that executes various processes for implementing the above-mentioned game machine service for the game machine 3. Incidentally, for example, an input device such as a keyboard and an output device such as a monitor can be connected to the control unit 21 as necessary. However, illustration thereof is omitted.

Meanwhile, the game machine 3 is provided with a control unit 31 as a computer and a storage unit 32 as a storage device. The control unit 31 is configured as a computer obtained by combining a CPU as an example of a processor that executes various processes according to a predetermined computer program, and peripheral devices such as an internal memory necessary for the action.

The storage unit 32 is an external storage device implemented by a storage unit including a non-volatile storage medium (computer-readable storage medium) such as a hard disk drive and a semiconductor storage device. The storage unit 32 records a game program PG2 as an example of a computer program that causes the control unit 31 to execute various processes necessary to provide various services such as a game. In addition, game data GD necessary to provide a game is recorded in the storage unit 32. Such game data GD can include various game data, such as play data, image data, music data, or ID management data. In the example of FIG. 2, the sequence data QD is showed as such game data GD.

Various game data GD such as the sequence data QD may be stored in the storage unit 32 by an appropriate method, and for example, the game data GD may be preinstalled in the game machine 3, or may be stored in the storage unit 32 via various recording media. In this way, the game data GD can be stored in the storage unit 32 by an appropriate method. As an example, the sequence data QD is provided by the center server 2 through a distribution service to include necessary parts.

In the control unit 31, various logical devices are configured by combining a hardware resource of the control unit 31 and the game program PG2 as a software resource. Various processes necessary to provide a game (including the processes necessary to enjoy the game machine service provided by the game machine service management unit 24 of the center server 2) are executed through the logical devices. The example of FIG. 2 shows a guide execution unit 33, a data management unit 34, and an evaluation execution unit 35 as the logical devices related to a game.

The guide execution unit 33 is a logical device that executes various processes for guiding a series of actions or the execution time of each action in a dance game. That is, the process executed by the guide execution unit 33 includes the process for guiding each action of a series of actions that constitute a dance and the execution time when each action is to be executed. For example, the guide execution unit 33 executes sequence processing as one of such processes. Details of the procedure for sequence processing will be described later.

The data management unit 34 is a logical device that executes various processes regarding the management of various data recorded in the storage unit 32. Such processes include the process of acquiring game data such as the sequence data QD from the center server 2, the process of updating the game data as appropriate, or the process of providing (sending) the game data to the center server 2.

The evaluation execution unit 35 is a logical device that executes various processes for evaluating the action (dance) executed by the user in the dance game. Through such processes, the evaluation execution unit 35 executes evaluations according to various actions required in the dance game. Therefore, the processes to be executed by the evaluation execution unit 35 include appropriate processes for evaluating various actions. As an example of such processes, the evaluation execution unit 35 executes the process to detect the user's action based on photographic results of a camera CA. Such a process may be implemented as appropriate based on various well-known arts, and for example, the process is implemented by analyzing the photographic results of the camera CA and acquiring bone information such as the position, orientation, and amount of displacement of the user's bone. In addition, the evaluation execution unit 35 also executes the process of evaluating the user's action based on such bone information. For example, the evaluation execution unit 35 executes action evaluation processing as one of such a process. Details of the procedure for the action evaluation processing will be described later.

In addition, the game machine 3 is appropriately provided with various output devices and input devices for functioning as an arcade game machine. Such an output device can include, for example, various lighting devices as appropriate, such as an LED lighting device for producing a dance game. The example of FIG. 2 includes a monitor MO and a speaker SP, as such output devices. The monitor MO is a well-known display device for displaying, for example, a game screen according to an output signal from the control unit 31. Similarly, the speaker SP is a well-known voice playback device for playing back various voices including music pieces according to the output signal from the control unit 31.

Similarly, the input device provided in the game machine 3 can include various devices for inputting play actions as appropriate, such as push button switches or touch panels. The example of FIG. 2 includes the camera CA, as the input device. The camera CA is a well-known optical device for photographing the user during play. The camera CA outputs a signal according to the photographic result to the control unit 31. Various detection devices for detecting the user's dance (action) as a play action can be connected to the control unit 31 as appropriate, such as various sensors installed on the body to detect the user's action (dance). In the example of FIG. 2, the camera CA is connected as an example of such a detection device.

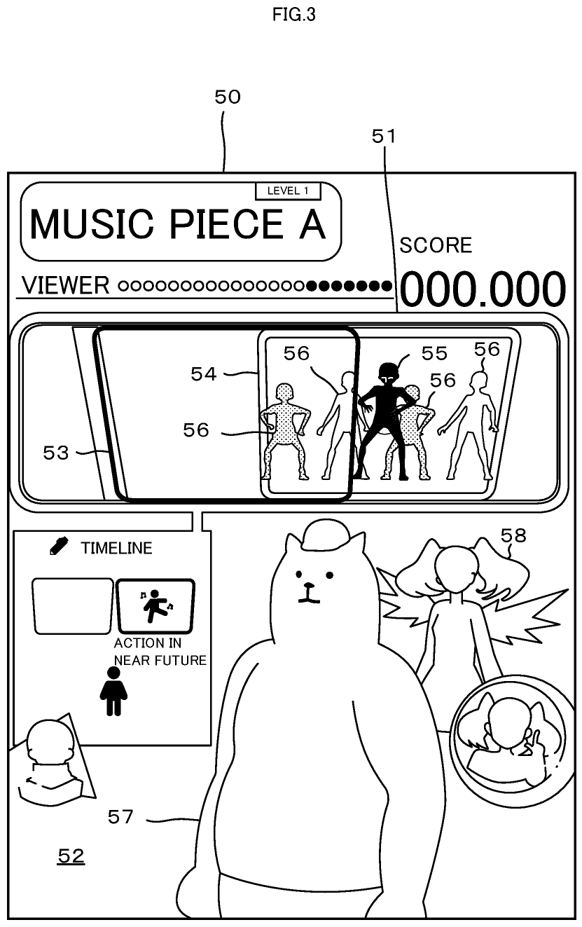

Next, the dance game will be described with reference to FIG. 3. FIG. 3 is a diagram schematically showing an example of a guide screen of the dance game. The guide screen is a game screen for guiding each action of a series of actions that constitute the dance and the execution time of each action. As shown in FIG. 3, the guide screen 50 includes a dance guide area 51 and a dance performance area 52. The dance guide area 51 is an area for guiding each action of a series of actions that constitute the dance and the execution time of each action. The dance guide area 51 may be formed into an appropriate form, and is formed into a substantial rectangle whose longitudinal direction is the left-right direction and includes a frame image 53 and a sample image 54 in the example of FIG. 3.

The sample image 54 is an image for guiding each action of a series of actions that constitute the dance. The sample image 54 may guide an action of an appropriate length, and guides a series of actions every predetermined duration as an example. That is, the series of actions is divided every predetermined duration, and is guided through the sample image 54 as each action (dance) to be executed by the user every predetermined duration. The predetermined duration may be set as appropriate and may differ between the sample images 54, and is uniformly set as a length of one measure as an example in all the sample images 54. In addition, one measure may be set as appropriate according to, for example, the music piece, but is set to four beats in the example of FIG. 3. That is, the sample image 54 is displayed to show the action every four beats in the series of actions. In this example, the sample image 54 functions as an action image of the present invention.

The sample image 54 may be formed into an appropriate shape, and is formed into a shape like an inverted trapezoid with the similar height to the dance guide area 51 in the example of FIG. 3. In addition, the sample image 54 may guide each action by an appropriate method, and may include various types of information as appropriate according to the method. In the example of FIG. 3, the sample image 54 includes a character video 55 and a plurality of still character images 56. The character video 55 is a video that reproduces (represents) the action for a predetermined duration (four beats) through the action of the character. Specifically, in the character video 55, the action that is executed during four beats is represented through the moving character. The character video 55 may be displayed in a similar mode to the still character image 56, but as an example, in order to be distinguished from the still character image 56, a different color scheme from each still character image 56 is used for the character video 55. That is, the character video 55 is displayed in a different mode from the still character image 56.

Meanwhile, the still character image 56 is an image of the character corresponding to a still image at predetermined intervals of the action of a predetermined duration represented by the character video 55. The predetermined interval may be set as appropriate, and is set to one beat as an example. That is, the still character image 56 is a still image that represents the action of the character video 55 as an action (posture) at every beat. The sample image 54 can include an appropriate number of still character images 56 according to the predetermined interval, and includes four still character images 56 each corresponding to the action every beat in the example of FIG. 3.

With only the character video 55, there is a possibility that the order of actions is difficult to be recognized, such as from the start action to the end action, or a break from the end action to the next start action. In addition, if all actions reproduced by the character video 55 are not checked, it is not possible to perceive the entire actions of the predetermined duration guided by each sample image 54. Meanwhile, with only each still character image 56, there is a possibility that the action of the predetermined duration is cut every beat, making it difficult to recognize the entire actions. The sample image 54, which includes both the character video 55 and each still character image 56, can solve the problems.

The four still character images 56 may be configured as appropriate. For example, the four still character images 56 may be displayed in a similar mode with the common conditions such as character, color scheme (including color shading), or size, other than differences in actions, and is displayed in a different mode based on predetermined conditions as an example. As such conditions, appropriate conditions such as whether the four still character images 56 are subject to evaluation or have a high-score posture can be used. As an example, a condition as to whether the posture corresponds to a characteristic posture is used. That is, the four still character images 56 are displayed such that the mode is different between the still character image 56 representing a characteristic action (posture) and the still character image 56 representing another action (for example, intermediate posture between characteristic postures).

In an action of a predetermined duration, the characteristic posture can occur at appropriate timing. Therefore, the characteristic posture can occur in an appropriate part or all of the four still character images 56 (there is no difference in the display mode within one sample image 54, but there are differences when compared with the still character images 56 of other sample images 54). In the example of FIG. 3, the characteristic posture occurs between the still character image 56 corresponding to odd-numbered beats and the still character image 56 corresponding to even-numbered beats. Specifically, the two still character images 56 corresponding to the first beat and the third beat are displayed in a dot pattern and are displayed darker than the two colorless still character images 56 corresponding to the second beat and the fourth beat. That is, the still character image 56 of odd-numbered beats corresponding to the characteristic posture is distinguished by color shading from the still character image 56 of even-numbered beats corresponding to a less characteristic posture. The difference in the display mode between the four still character images 56 may be used as various types of information as appropriate, and is used as information on whether the posture (pose) is characteristic in this way as an example. If there is information on such a characteristic posture (emphasized through shading), it will be easier for the user to dance. In this example, the still character image 56 of odd-numbered beats and the still character image 56 of even-numbered beats function as a characteristic still character image and another still character image of the present invention, respectively.

The sample image 54 appears at the right end of the dance guide area 51 such that the dance guide area 51 itself functions as a movement route, and gradually moves at an appropriate speed toward the frame image 53 located on the opposite side. Therefore, the left-right direction (more specifically, direction from the right end to the left end) functions as a time axis. The four still character images 56 and the character video 55 may be appropriately arranged in the sample image 54. In the example of FIG. 3, the four still character images 56 are arranged in chronological order at intervals corresponding to one beat in relation to the movement speed so as to correspond to the time axis. Meanwhile, the character video 55 is arranged near the center in the left-right direction so as to be located in front of each still character image 56 (on the side closer to the user in the depth direction).

The frame image 53 is an image that functions as a marker indicating the current time. The frame image 53 is placed near the left end in the dance guide area 51 so as to function as an arrival position of the sample image 54. In addition, the frame image 53 may be configured as appropriate, but is formed into a similar shape to the sample image 54 as an example. However, the frame image 53 is displayed more emphasized than the sample image 54 so as to be distinguished from the sample image 54. Such emphasis (distinction) may be implemented as appropriate, and in the example of FIG. 3, the periphery of the frame image 53 is displayed thicker than the sample image 54. In addition, the sample image 54 is displayed such that the background is transparent, and the sample image 54 fits there. The user is required to execute the similar action (posture) to the still character image 56 that overlaps with the right end of the frame image 53 in accordance with the time when each still character image 56 of the sample image 54 overlaps with the right end of the frame image 53. That is, the execution time of the action indicated by each still character image 56 of the sample image 54 is sequentially guided through the overlap between the right end of the frame image 53 and the still character image 56. Then, the display of the sample image 54 is controlled such that the part that reaches the left end of the frame image 53 gradually disappears.

The dance performance area 52 is an area for displaying characters that perform a dance performance. Various characters may be displayed in the dance performance area 52 as appropriate. In the example of FIG. 3, two types of characters, a main character 57 and a sub character 58 are displayed. The main character 57 is a character corresponding to the user playing the dance game. Various characters may be appropriately employed as the main character 57, and in the example of FIG. 3, a character imitating a bear is employed.

The main character 57 may perform an appropriate dance as a dance performance, and may similarly perform (reproduce), for example, a dance (a series of actions) performed by the user to reflect (trace) the user's action (this may be only an appropriate part of the user, such as an arm or a leg, for the purpose of, for example, suppressing a delay based on various processes including communication, analysis, or the like). As an example, the main character 57 performs a dance that is a model to be performed at each time. That is, the main character 57 sequentially executes the actions (dance) guided by the sample image 54 through, for example, the character video 55 when the sample image 54 reaches the frame image 53. In this case, to assist in perceiving the difference between the model dance and the user's actual dance, an image showing the user's action may further be displayed to be superimposed on the main character 57. Incidentally, the image showing the user's action displayed to be superimposed on the main character 57 may also be an image showing the action of an appropriate part of the user, such as an arm or a leg. In this case, as described above, the delay based on, for example, communication can be suppressed. In particular, when the image showing the user's action is displayed to be superimposed on the main character 57, if a delay occurs based on, for example, communication, there is a possibility that the user will be more likely to bodily sense the delay by comparing the two images. When a part of, for example, the arm is displayed as the image showing the user's action, in addition to suppressing the delay based on communication or the like, since the object of comparison can be limited to the part, such a bodily sensation can be further suppressed.

Meanwhile, the sub character 58 is a character that assists the dance performance of the main character 57. An appropriate number of sub characters 58 may be displayed in the dance performance area 52. As an example, two sub characters 58 are displayed (in the example of FIG. 3, one sub character 58 is hidden behind the other display, and only one sub character 58 is displayed). Various characters may be appropriately employed as the sub character 58, in a similar manner to the main character 57, and in the example of FIG. 3, a female character is employed. The sub character 58 may perform an appropriate dance as a dance performance, and may perform a different dance from the main character 57, for example, to produce the dance of the main character 57. As an example, the sub character 58 performs a similar dance to the dance of the main character 57. That is, the sub character 58 also performs a model dance, and a series of dances to be performed by the user is guided through not only the sample image 54 but also the dance performance of the main character 57 and the sub character 58.

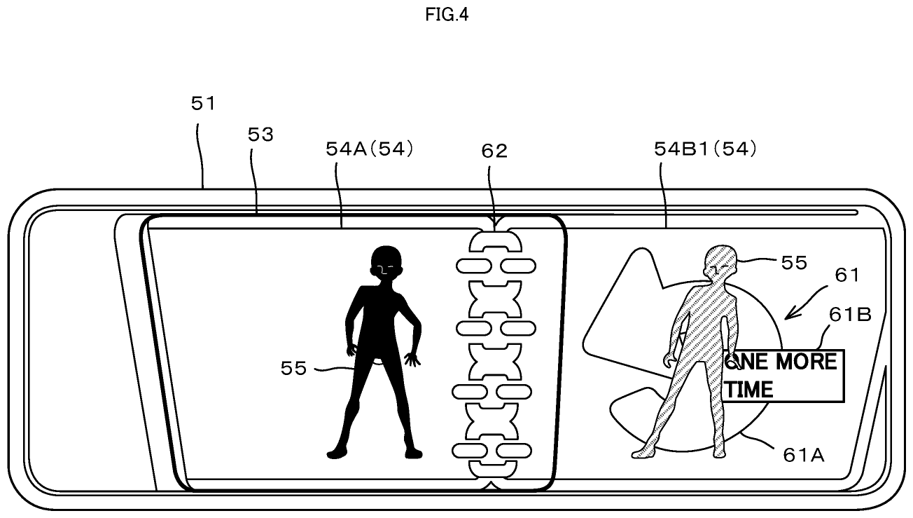

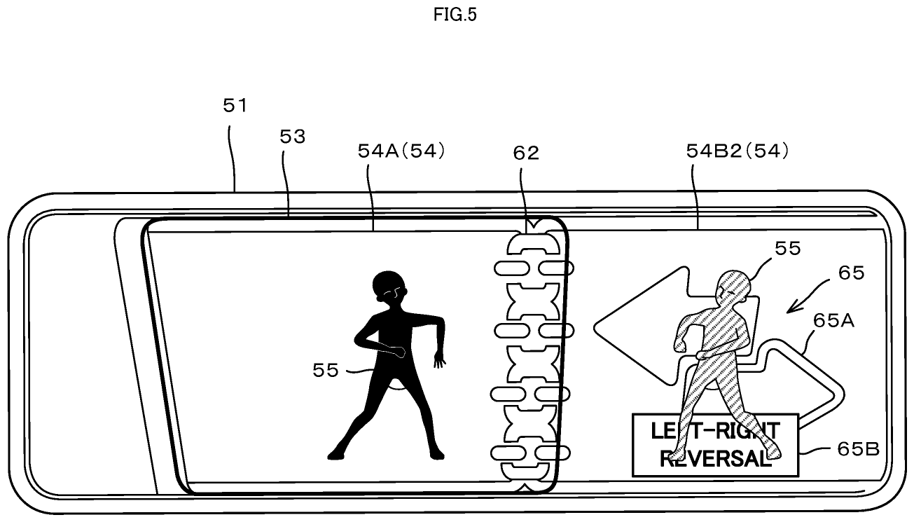

Next, the type of the sample image 54 will be described with reference to FIGS. 4 and 5. There may be only one type of sample image 54, but as an example, the sample image 54 includes two types: a normal type sample image 54 and a related type sample image 54. The normal type sample image 54 is a sample image 54 for actually displaying actions through the character video 55 and the still character image 56, and corresponds to the sample image 54 in the example of FIG. 3. Meanwhile, the related type sample image 54 is a sample image 54 for displaying related information showing the relevance with the action guided by the immediately preceding sample image 54. A series of actions that constitute a dance may include various actions as appropriate, and for example, as the action related to the immediately preceding action, a related action to be executed based on the immediately preceding action may be included. Guidance of such a related action may also be implemented through the normal type sample image 54 as well in a similar manner to other actions, but as an example, the guidance is implemented through the related type sample image 54 that differs from the normal type sample image 54 in at least the presence or absence of the related information. In the following, when a distinction is made between the normal type sample image 54 and the related type sample image 54, the two images are described with different symbols, such as a normal type sample image 54A and a related type sample image 54B.

The related action may include various actions as appropriate, and can include various actions whose relevance is determined based on the immediately preceding action, for example, an action that differs only in speed from the immediately preceding action, a reverse return action that reverses the time axis of the action, and the same action to be executed by a different user from the immediately preceding action for a plurality of plays. As an example, the related action includes two types of actions: a repeat action and a reverse action (mirror action). The repeat action is an action of repeatedly executing the same action as the immediately preceding action. The reverse action is an action defined as an action in which at least part of the immediately preceding action is reversed (opposite action). The related type sample image 54B includes two types of images: a repeat type sample image and a reverse type sample image for guiding the repeat action and the reverse action, respectively.

FIG. 4 is a diagram schematically showing an example of the repeat type sample image. More specifically, the example of FIG. 4 schematically shows the dance guide area 51 in an enlarged format when the repeat type sample image is displayed. As shown in FIG. 4, the repeat type sample image 54B1 includes the character video 55 and a repeat image 61. The character video 55 is as described above. The character video 55 may be displayed in exactly the same mode as the normal type sample image 54A, but with a different color scheme as an example. That is, the normal type sample image 54A and the repeat type sample image 54B1 may be distinguished as appropriate, and is distinguished by such a difference in color scheme as an example.

The repeat image 61 is one type of related information that shows the relevance with the immediately preceding sample image 54 corresponding to one image before the repeat type sample image 54B1. Specifically, the repeat image 61 is related information for guiding the repeat action as the related action. The repeat image 61 may be configured as appropriate as long as the repeat image can guide the repeat action. In the example of FIG. 4, the repeat image 61 includes a repeat arrow image 61A and text information 61B. The repeat arrow image 61A is configured in a substantially circular shape in a counterclockwise direction, and plays a role of visually indicating repetition. Meanwhile, the text information 61B includes characters “One More Time” and plays a role of explaining the repeat action through the characters. Such a repeat image 61 may be additionally displayed in the sample image 54, but is displayed instead of the still character image 56 in the example of FIG. 4. That is, the repeat image 61 is displayed to replace the still character image 56 as the related information that guides the repeat action. In this example, the repeat image 61 functions as the related image and the repeat image of the present invention.

The repeat type sample image 54B1 may be displayed independently of the immediately preceding sample image 54, but is connected to the immediately preceding sample image 54 to show the relevance with the immediately preceding action and is displayed continuously in the example of FIG. 4. Specifically, the repeat type sample image 54B1 is connected to the immediately preceding sample image 54 via a connection image 62 and is displayed as being continuous with the immediately preceding sample image 54. The connection image 62 is an image for connecting the immediately preceding sample image 54 to the repeat type sample image 54B1 and also functions as information indicating the relevance therebetween. Incidentally, the repeat type sample image 54B1 may be displayed integrally (continuously) with the immediately preceding sample image 54 (or vice versa, the immediately preceding sample image 54 is displayed integrally with the repeat type sample image 54B1), and the connection image 62 may be omitted. In this case, the relevance between the repeat type sample image 54B1 and the immediately preceding sample image 54 can be emphasized more.

The immediately preceding sample image 54 may gradually disappear from the left end of the frame image 53 as time elapses in a similar manner to the sample image 54 that is shown separately, but a different effect from the sample image 54 that is displayed separately is added in the example of FIG. 4. Specifically, in the immediately preceding sample image 54 connected to the repeat type sample image 54B1, whereas all the still character images 56 disappear when reaching the right end of the frame image 53, the character video 55 remains displayed.

In addition, various sample images 54 may function appropriately as the immediately preceding sample image 54. For example, the repeat type sample image 54B1 (that is, repeat of repeat action) or the related type sample image 54B such as the reverse type sample image may function. In the example of FIG. 4, the normal type sample image 54A functions. Therefore, the difference in the color scheme of the character video 55 is represented by black color and diagonal lines to the right between the normal type sample image 54A (immediately preceding sample image 54) and the repeat type sample image 54B1. The character video 55 of the immediately preceding sample image 54 may disappear as appropriate, but as an example, the character video 55 will disappear at the timing when overlapping with the character video 55 of the repeat type sample image 54 (next sample image 54) (this also corresponds to the timing when the right end of the immediately preceding sample image 54 reaches the left end of the frame image 53 if the immediately preceding sample image 54 and the next sample image 54 have the same length and the character video 55 is located near the same center).

FIG. 5 is a diagram schematically showing an example of a reverse type sample image. More specifically, the example of FIG. 5 schematically shows the dance guide area 51 in an enlarged format when the reverse type sample image is displayed. In addition, in a similar manner to the repeat type sample image 54B1, the example of FIG. 5 shows the case where connection is made to the immediately preceding sample image 54 (normal type sample image 54A) via the connection image 62, and all the still character images 56 of the immediately preceding sample image 54 disappear when reaching the right end of the frame image 53, whereas the display of the character video 55 remains. In this case, as shown in FIG. 5, the reverse type sample image 54B2 includes the character video 55 and a reverse image 65.

The character video 55 is similar to the repeat type sample image 54B1. The reverse image 65 is one type of the related information that shows the relevance with the immediately preceding sample image 54. Specifically, the reverse image 65 is related information for guiding the reverse action as the related action. That is, in the reverse type sample image 54B2, the reverse image 65 is displayed as the related information instead of the repeat image 61. Various actions in which the immediately preceding action is reversed according to a predetermined rule may be appropriately guided as the reverse action, such as the action of reversing an appropriate section such as an arm or leg with respect to an appropriate reference such as up and down or right and left, or the action of reversing the rotation direction of the action of rotating the whole body. In the example of FIG. 5, the action of reversing the left and right action based on the center line of the body is guided, such as the action of raising the left arm with respect to the action of raising the right arm. The reverse image 65 may be configured as appropriate as long as the reverse image can guide such a reverse action, and the example of FIG. 5 includes a reverse arrow image 65A and text information 65B.

The reverse arrow image 65A includes two arrows pointing left and right, plays a role of visually indicating left-right reversal. Meanwhile, the text information 65B includes characters “Left-Right Reversal” and plays a role of explaining the action of reversing left and right through the characters. Such a reverse image 65 may be additionally displayed in the sample image 54, but is displayed instead of the still character image 56 in the example of FIG. 5. That is, the reverse arrow image 65A is displayed as the related information, that guides the reverse action to replace the still character image 56 in a similar manner to the repeat image 61. The related information may be implemented as appropriate, and as an example, the related information is implemented through the repeat image 61 and the reverse image 65. Then, through the related type sample image 54B such as the repeat type sample image 54B1 and the reverse type sample image 54B2, various related actions such as the repeat action or the reverse action are guided. In the example, the reverse arrow image 65A functions as the related image and the reverse image of the present invention. In addition, the related type sample image 54B such as the repeat type sample image 54B1 and the reverse type sample image 54B2 function as the related action image of the present invention.

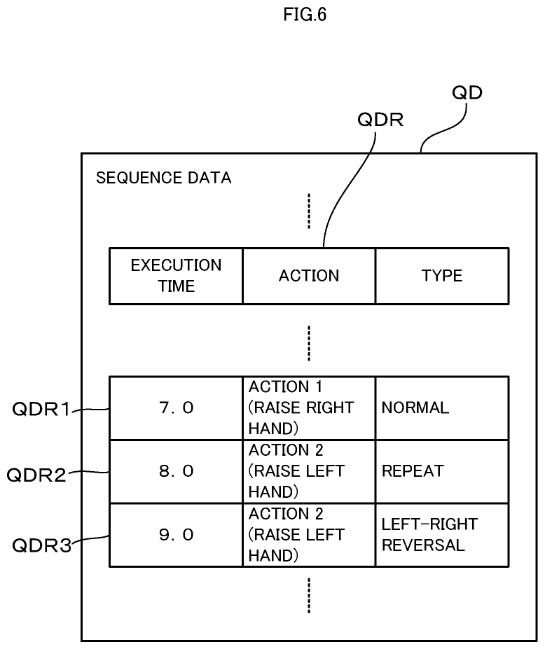

Next, details of the sequence data QD will be described. FIG. 6 is a diagram showing an example of a configuration of the sequence data QD. The sequence data QD can appropriately include various pieces of information related to the guidance of each action and the execution time of the action, and the example of FIG. 6 shows a part related to the guidance of the related action. As shown in FIG. 6, the sequence data QD includes, for each action, a sequence record QDR for managing information regarding guidance of the action. In addition, to implement such management, the sequence record QDR includes information on “execution time”, “action”, and “type”. In the sequence record QDR, the information is recorded in association with each other. Incidentally, the sequence data QD may include, but is not limited to, each action, guidance of the execution time of the action, or appropriate information necessary for evaluation. Alternatively, each piece of the above information may be omitted as appropriate.

The “execution time” is information indicating the execution time when each action of the series of actions that constitute a dance is to be executed. In the “execution time”, information on the time that is appropriately specified by various methods may be described as the execution time, and for example, information about the elapsed time from the start of a music piece is described. The “action” is information indicating each action of the series of actions that constitute a dance. Each action may be defined as appropriate, and in the “action”, information on such an appropriately defined action is described. The “type” is information indicating the type of the sample image 54. As described above, the sample image 54 includes the type of the normal type sample image 54A, the repeat type sample image 54B1, and the reverse type sample image 54B2. Therefore, information for distinguishing these images is described in the “type”.

Specifically, the sequence record QDR includes a normal type record QDR1, a repeat type record QDR2, and a reverse type record QDR3 for guiding the action through the normal type sample image 54A, the repeat type sample image 54B1, and the reverse type sample image 54B2, respectively. The records QDR1, QDR2, and QDR3 all include the information on “execution time”, “action”, and “type” as described above. In the example of FIG. 6, information of “7.0”, “8.0”, and “9.0” are respectively described as the information on the “execution time”. In addition, in the “action”, information on “action 1”, “action 1”, and “action 2” are described. The action 1 corresponds to the action of raising the right hand, and the action 2 corresponds to the action of raising the left hand (action that is left-right reversal of the action of raising the right hand). Meanwhile, in the “type”, information on “normal”, “repeat”, and “left-right reversal” is described. Normal, repeat, and left-right reversal are information on the type indicating the normal type sample image 54A, the repeat type sample image 54B1, and the reverse type sample image 54B2, respectively.

In the example of FIG. 6, the normal type sample image 54A including, for example, the character video 55 that represents the action of raising the right hand is displayed such that the left end of the sample image 54 reaches the right end of the frame image 53 when seven seconds elapse from the start of a music piece based on the normal type record QDR1. Meanwhile, the repeat type sample image 54B1 is displayed such that the left end of the sample image 54 reaches the right end of the frame image 53 when eight seconds elapse from the start of a music piece based on the repeat type record QDR2, that is, one second after the arrival of the immediately preceding sample image 54 (normal type sample image 54A). Furthermore, the reverse type sample image 54B2 is displayed such that the left end of the sample image 54 reaches the right end of the frame image 53 when nine seconds elapse from the start of a music piece based on the reverse type record QDR3, that is, further one second after the arrival of the immediately preceding sample image 54 (repeat type sample image 54B1). Then, the user is requested to execute in order, as each action of the series of actions, the action of raising the right hand at one-second intervals, the action of repeating the above action, and the action of reversing the above action (action of raising the left hand).

Incidentally, in the example of FIG. 6, the sequence record QDR is shown in units of the type of the sample image 54 for convenience of description, but the sequence record QDR may be prepared in units of action indicated by each still character image 56 (that is, every still character image 56). In this case, the sequence record QDR may include unique number information for each still character image 56 as information for identifying each still character image 56 (for example, this may be a combination of number information for identifying each sample image 54 and number information for identifying each still character image for each sample image 54). Alternatively, if the evaluation target is limited to a part of, for example, the characteristic posture among the still character images 56, the sequence record QDR may further include information for determining the evaluation target.

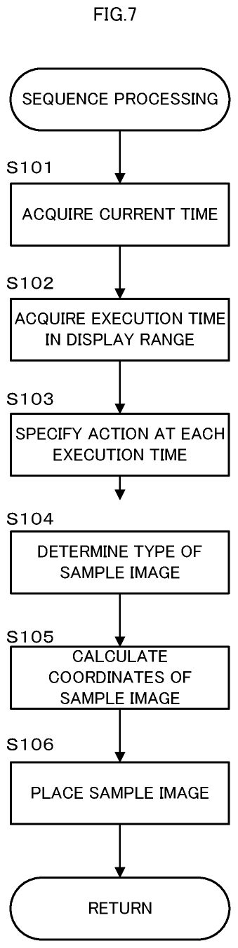

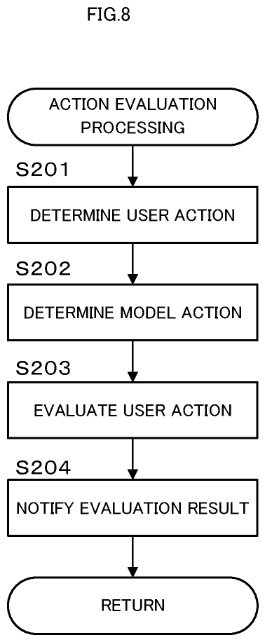

Next, with reference to FIGS. 7 to 8, the procedure for the sequence processing and the action evaluation processing will be described. The sequence processing is a process for guiding each action of a series of actions that constitute a dance and the execution time of each action. The guide execution unit 33 repeatedly starts the sequence processing in FIG. 7 at a predetermined cycle as the display of the guide screen 50 starts, and first acquires the current time (step S101). The guide execution unit 33 specifies the time on a music piece based on, for example, the elapsed time from the time when the playback of the music piece starts.

Subsequently, the guide execution unit 33 acquires the sequence record QDR corresponding to each execution time that exists in the time length equivalent to the display range of the guide screen 50 from the sequence data QD (step S102). As the display range, for example, a time range equivalent to two measures of the music piece from the current time toward the future is set (for example, the time range required when the sample image 54 moves at a predetermined movement speed from the farthest appearance position to the arrival position).

Next, the guide execution unit 33 specifies each action to be executed at each execution time of the sequence record QDR acquired in step S102 (step S103). Specifically, with reference to information on the “action” in each sequence record QDR, the guide execution unit 33 specifies each action such as the action of raising the right hand (action 1) or the action of raising the left hand (action 2).

Subsequently, the guide execution unit 33 determines the type of the sample image 54 to be used to guide each action (step S104). Specifically, with reference to information on the “type” in each sequence record QDR, the guide execution unit 33 determines the type of the sample image 54 such as the normal type sample image 54A, the repeat type sample image 54B1, and the reverse type sample image 54B2.

Next, the guide execution unit 33 calculates coordinates of the sample image 54 corresponding to each action about the left-right direction in the dance guide area 51 (step S105). The guide execution unit 33 can execute the calculation as appropriate, and executes the calculation as follows as an example. That is, the guide execution unit 33 first determines the position on the dance guide area 51 (moving route) in the time axis direction (that is, left-right direction, which is the movement direction of the sample image 54) from the frame image 53 (arrival position) according to the time difference between each execution time and the current time. As a result, the coordinates necessary to place the sample image 54 on the dance guide area 51 from the frame image 53 along the time axis are acquired.

Subsequently, the guide execution unit 33 places each sample image 54 in the dance guide area 51 such that each sample image 54 indicating the action specified in step S103 is displayed at the coordinate position in the left-right direction on the dance guide area 51 calculated in step S105 (step S106). In addition, the guide execution unit 33 reflects the type of each sample image 54 in this placement. Specifically, for example, when the type of the sample image 54 is normal, the guide execution unit 33 places the normal type sample image 54A including the character video 55, and the like corresponding to the action specified in step S103 as the sample image 54. Similarly, when the type of the sample image 54 is repeat or left-right reversal, the guide execution unit 33 places the repeat type sample image 54B1 including, for example, the character video 55 corresponding to the action specified in step S103, or the reverse type sample image 54B2, as the sample image 54. Then, the guide execution unit 33 finishes the sequence processing this time after such placement.

By the procedure of FIG. 7, the sample image 54 according to the type such as the normal type sample image 54A, the repeat type sample image 54B1, and the reverse type sample image 54B2 is displayed at a proper position on the dance guide area 51 (that functions as the time axis). In addition, the sample image 54 includes, for example, the character video 55 that represents each action. Specifically, the normal type sample image 54A is displayed to include the still character image 56 for guiding the action such as the action of raising the right hand, and the character video 55. In addition, the related information such as the repeat image 61 indicating the repetition of the immediately preceding action or the reverse image 65 indicating the action that reverses the immediately preceding action, and the repeat type sample image 54B1 including the character video 55 corresponding to these actions or the reverse type sample image 54B2 are displayed. Then, the position of the sample image 54 gradually moves (displaces) toward the frame image 53 as time elapses (music piece progresses) such that the left end of the sample image 54 agrees with the right end position of the frame image 53 at the execution time. That is, in the guide screen 50, the display of the sample image 54 moving to guide each action and the execution time of the action is implemented.

Meanwhile, the action evaluation processing is a process for evaluating the action (dance) actually executed by the user. The user's action may be evaluated appropriately as needed. The example of FIG. 8 shows the action evaluation processing when evaluating the user's action at the execution time of the sequence data QD based on the execution time, by comparison with the action described in the sequence data QD as the action to be executed at the execution time. In this case, the evaluation execution unit 35 starts the action evaluation processing of FIG. 8 every time the evaluation period that is set based on the execution time of the sequence data QD (period including the predetermined period before and after the execution time) arrives, and first determines the user's action (step S201). The user's action is determined based on the photographic result of the camera CA, as described above.

Subsequently, the evaluation execution unit 35 determines a model action (step S202). The model action is an action to be executed at the execution time of the sequence data QD, that is, an action described to be associated with the execution time in the sequence data QD. Therefore, with reference to the “action” of the sequence data QD, the evaluation execution unit 35 determines the action described there as the model action.

Next, the evaluation execution unit 35 evaluates the user's action determined in step S101 based on the model action determined in step S202 (step S203). The evaluation execution unit 35 can evaluate the user's action as appropriate, and evaluates the user's action based on positions (coordinates) of four points of fingers and toes based on bone information as an example. Specifically, based on the pose (posture) of the model action (action of the character video 55) at the execution time, the evaluation execution unit 35 sets the coordinate range where the fingers and toes should be located, and determines whether the positions of, for example, the user's fingers are located in the coordinate range. The evaluation of the positions of the fingers, and the like based on the coordinate range may be executed as appropriate. For example, the evaluation may be executed in a plurality of stages, such as the best result (for example, perfect) when all of the four points such as the fingers are located in the coordinate range, success (for example, good) when half or more are located, and failure (for example, mistake) when one location or less is located. As an example, the evaluation is executed to determine success (scores added) when four locations are located, and failure (scores are not added or may be subtracted) in other cases. That is, if the positions of the fingers and toes agree with the coordinate range, even if the actual pose differs from the pose in the model action, the evaluation will be success. The evaluation execution unit 35 may further reflect, in the evaluation result, the time difference between the time of the user's action of positioning, for example, the fingers at the coordinate position and the execution time. As an example, if the user's action is executed during the evaluation period, the evaluation execution unit 35 evaluates the user's action uniformly as a similar result.

In addition, the evaluation execution unit 35 may execute evaluation of the above-described pose for each appropriate posture in the model action, may execute evaluation, for example, for each posture of the still character image 56 included in each sample image 54, and may execute evaluation only in an appropriate specific posture such as the central still character image 56. As an example, the evaluation execution unit 35 may execute evaluation for each posture of the still character image 56 that is displayed darkly (indicating characteristic posture). In this case, the execution time is described for each characteristic posture in the sequence data QD, and for example, the determination of the model action (characteristic posture) in step S202 is also executed at each execution time.

Subsequently, the evaluation execution unit 35 notifies the user of the evaluation result of step S203 (step S204). The notification may be implemented as appropriate, for example through voice, and as an example, the notification is implemented through display on the guide screen 50. That is, the evaluation execution unit 35 controls the monitor MO such that the evaluation result of step S203 is displayed on the guide screen 50. Then, after the display (notification), the evaluation execution unit 35 finishes the action evaluation processing this time. With this operation, the user's action is evaluated based on the model action described in the sequence data QD. Specifically, the pose (posture) of the user at the execution time when the posture is to be executed is evaluated based on the characteristic posture of the model actions guided through the sample image 54.

As described above, according to this embodiment, if the action of the next sample image 54 is a related action of the action of the previous sample image 54, such as the repeat action or the reverse action, the related type sample image 54B is displayed instead of the normal type sample image 54A, and through the repeat image 61 or the reverse image 65 included in the related type sample image 54B, the related information indicating the relevance between the previous action and the next action is provided to the user. Therefore, through such related information, the user can perceive the next action based on the previous action (or the action that is currently being executed). That is, when the next action is the related action related to the previous action, through the related type sample image 54B, the related information such as the repeat image 61 can be provided to the user as information for assisting in perceiving the next action.

When the related type sample image 54B is displayed instead of the normal type sample image 54A, the user no longer needs to perceive all the actions of each sample image 54, leading to a decrease in the density of information that has to be processed. Therefore, unnecessary increases in the difficulty level of the game can be suppressed. As a result, it is possible to achieve both promotion of an ideal dance and, for example, suppression of unnecessary increase in the difficulty level, which in turn enhances the interest in the game.

In addition, when the related type sample image 54B includes not only the related information such as the repeat image 61 but also the character video 55, even if there are many repeat actions and reverse actions in a row, it is possible to suppress the action to be executed through the character video 55 from being forgotten. Meanwhile, if the display mode of the character video 55 is different between the normal type sample image 54A and the related type sample image 54B, such a difference in the display mode can be used as one type of the related information. Therefore, through the display mode of the character video 55, it is possible to recognize relatively quickly whether the next action corresponds to the related action. If it is possible to perceive at an early stage that the next action corresponds to the related action, the user only needs to perceive the immediately preceding action (including the action currently being executed), making it possible to implement the use of different recognitions. This makes it possible to further suppress, for example, unnecessary increases in the difficulty level.

In the above-described embodiment, the guide execution unit 33 of the game machine 3 functions as an action specifying unit and an information providing unit of the present invention by executing the procedure of FIG. 7. Specifically, the guide execution unit 33 functions as the action specifying unit by executing step S103 in FIG. 7, and functions as the information providing unit by executing step S106 (when placing the related type sample image 54B).

The present invention may not be limited to the above-described embodiment, and may be implemented by the embodiment to which appropriate modifications or changes are made. For example, in the above-described embodiment, information on the type of the sample image 54 is described in the sequence data QD. However, the present invention is not limited to such an embodiment. For example, the type of the sample image 54 may be determined for each process based on the information on the “action” in the sequence data QD. Specifically, for example, the guide execution unit 33 may determine whether the next action and the previous action correspond to the same action in step S104, and when corresponding to the same action, the type of the sample image 54 may be determined as the repeat type sample image 54B1. Similarly, the guide execution unit 33 may determine whether the next action and the previous action correspond to the reverse action according to a predetermined rule in step S104, and when corresponding to the reverse action, the type of the sample image 54 may be determined as the reverse type sample image 54B2. That is, the type of the sample image 54 (in other words, whether to correspond to the related action) is not set in advance and may be determined for each process.

In the above-described embodiment, the repeat image 61 and so on function as the related information. However, the related information of the present invention is not limited to such an embodiment. For example, the color scheme of the character video 55 or the connection image 62 may function as the related information. In this case, the relevance of such as the repeat action may be distinguished as appropriate through, for example, the character video 55 or the mode of the connection image 62 (including color scheme, size, shape), and may be distinguished through the action represented by the character video 55. That is, not only, for example, the repeat image 61, but also various types of information may be used as the related information as appropriate.

In the above-described embodiment, the related information is provided to the user through the repeat image 61 of the related type sample image 54B and so on presented on the guide screen 50. However, the present invention is not limited to such an embodiment. For example, the related information, that is, the relevance between the previous action and the next action may be provided to the user as appropriate through various output devices such as the speaker SP or lighting devices. Specifically, the related information may be provided to the user as voice information through the speaker SP. Alternatively, the related information may be provided to the user through a difference in lighting methods by various lighting devices, such as color scheme of LED lighting.

In addition, in the above-described embodiment, the game machine 3 executes the processes of FIGS. 7 to 8. As a result, the game machine 3 functions standalone as the game system of the present invention. However, the present invention is not limited to such an embodiment. For example, when the game machine 3 functions standalone as the game system of the present invention, the center server 2 may be omitted. In addition, for example, the center server 2 may execute all or part of the role of the game machine 3 (for example, processes of FIGS. 7 and 8). Therefore, for example, if the center server 2 executes all the processes of FIGS. 7 and 8, the center server 2 standalone (including the case implemented by a combination of a plurality of server devices) may function as the game system of the present invention.

Various aspects of the present invention derived from each of the above-described embodiment and modifications will be described below. Incidentally, in the following description, to facilitate understanding of each aspect of the present invention, corresponding members illustrated in the accompanying drawings are added in parentheses, which however does not limit the present invention to the illustrated embodiment.

A game system of the present invention is a game system (3) comprising a computer (31) connected to an output device (MO) including a display device (MO) that displays a game screen (50) in which an action image (54) showing each action of a series of actions that constitute a dance is presented in order of the series of actions and a detection device (CA) that detects a user's action, and providing a timing game that guides each action and execution time of each action through the action image and evaluates the user's action, wherein the computer serves as: an action specifying unit (33) that specifies one action of the series of actions and a next action that follows the one action based on sequence data (QD) in which each action of the series of actions and the execution time to execute each action are described in association with each other; and an information providing unit (33) that provides the user with related information indicating relevance between the one action and the next action through the output device when the next action is a related action to be executed based on the one action as an action related to the one action.

According to the present invention, when the next action is the related action of one action (previous action), the related information indicating the relevance between the one action and the next action is provided to the user. Therefore, through such related information, the user can perceive the next action based on the previous action (or the action that is currently being executed). That is, when the next action is the related action related to the previous action, the related information can be provided to the user as information for assisting in perceiving the next action. As a result, it is possible to achieve both promotion of an ideal dance and, for example, suppression of unnecessary increase in the difficulty level, which in turn enhances the interest in the game.

The output device may appropriately include various devices other than the display device. For example, the output device may include a device such as a voice playback device that plays back various voices for producing a dance or a lighting device. Then, the related information may be provided to the user as appropriate through such various devices, for example, a voice explaining the relevance, lighting of a color scheme that indicates the relevance. Specifically, for example, in one aspect of the game system of the present invention, by presenting a related image (61, 65) indicating the relevance on the game screen, the information providing unit may provide the user with the related image as the related information through the game screen.

The related action may appropriately include various actions related to the one action. For example, the related action may include actions such as an action identical to the one action with a different action speed, a reverse return action with a reverse time axis to the one action so as to rewind the one action, or a target change action where the user who should execute the action is changed from the one action when the timing game is played by a plurality of users. Specifically, for example, in an aspect where the related image is presented as the related information, the related action may include a repeat action that repeatedly executes an action identical to the one action based on the one action, and when the next action is the repeat action, the information providing unit may present a repeat image (61) indicating the repeat action on the game screen as the related image. In addition, the related action may include a reverse action defined as an action that is obtained by reversing the one action according to a predetermined rule based on the one action, and when the next action is the reverse action, the information providing unit may present a reverse image (65) indicating the reverse action on the game screen as the related image.

The related image may be presented on the game screen through various methods. For example, the related image may be presented separately from the action image on the game screen, or may be presented in the action image. In addition, the related image may be displayed additionally on the game screen, or may be displayed to replace an appropriate part of the game screen. Specifically, all or an appropriate part of the action image may be replaced with the related image. In addition, when a part of the action image is replaced, the part may be an appropriate part. For example, in an aspect where the related image is presented as the related information, when the next action is the related action, by displaying a related action image (54B) including the related image as the action image corresponding to the next action, the information providing unit may present the related image on the game screen via the related action image such that the action image corresponding to the one action and the related action image differ at least in presence or absence of the related image. In addition, in the aspect, the action image may be configured to indicate an action in a predetermined duration in the series of actions, and may include a character video (55) that reproduces the action in the predetermined duration through the action of the character and a plurality of still character images (56) corresponding to still images at predetermined intervals in the character video, and the information providing unit may display the related action image on the game screen such that the related image is included instead of the plurality of still character images.

The plurality of still character images may be displayed as appropriate. For example, these images may be displayed uniformly in the same mode, or may include still character images of a different mode as appropriate. Specifically, the plurality of still character images may be displayed, for example, uniformly with the same character, color scheme (including shading of the same color), and size. Alternatively, in a part or all of the plurality of still character images, at least one of the character, color scheme, or size may be different. In addition, such a difference may occur based on appropriate conditions such as whether a characteristic posture or not, whether an evaluation target or not, or whether a high score or not. For example, in an aspect where the action image includes a plurality of still character images, the plurality of still character images may include a characteristic still character image (56) as the still character image corresponding to the characteristic posture of the character in the character video, and may be displayed such that a display mode is different between the characteristic still character image and another still character image (56).

Meanwhile, a non-transitory computer readable storage medium of the present invention is a non-transitory computer readable storage medium storing a computer program (PG2) configured to cause a computer (31) connected to the output device and the detection device to function as each unit of the game system described above.

In addition, a control method of the present invention is a control method executed by a computer (31) incorporated in a game system (3) that is connected to an output device (MO) including a display device (MO) that displays a game screen (50) in which an action image (54) showing each action of a series of actions that constitute a dance is presented in order of the series of actions and a detection device (CA) that detects a user's action, and provides a timing game that guides each action and execution time of each action through the action image and evaluates the user's action, wherein the control method comprises: an action specifying procedure that specifies one action of the series of actions and a next action that follows the one action based on sequence data (QD) in which each action of the series of actions and the execution time to execute each action are described in association with each other; and an information providing procedure that provides the user with related information indicating relevance between the one action and the next action through the output device when the next action is a related action to be executed based on the one action as an action related to the one action. By executing the computer program or control method of the present invention, the game system of the present invention can be implemented.

1. A game system comprising a computer connected to an output device including a display device that displays a game screen in which an action image showing each action of a series of actions that constitute a dance is presented in order of the series of actions and a detection device that detects a user's action, and providing a timing game that guides each action and execution time of each action through the action image and evaluates the user's action, wherein the computer serves as:
an action specifying unit that specifies one action of the series of actions and a next action that follows the one action based on sequence data in which each action of the series of actions and the execution time to execute each action are described in association with each other; and
an information providing unit that provides the user with related information indicating relevance between the one action and the next action through the output device when the next action is a related action to be executed based on the one action as an action related to the one action.

2. The game system of claim 1, wherein by presenting a related image indicating the relevance on the game screen, the information providing unit provides the user with the related image as the related information through the game screen.

3. The game system of claim 2, wherein the related action includes a repeat action that repeatedly executes an action identical to the one action based on the one action, and
when the next action is the repeat action, the information providing unit presents a repeat image indicating the repeat action on the game screen as the related image.

4. The game system of claim 2, wherein the related action includes a reverse action defined as an action that is obtained by reversing the one action according to a predetermined rule based on the one action, and
when the next action is the reverse action, the information providing unit presents a reverse image indicating the reverse action on the game screen as the related image.

5. The game system of claim 2, wherein when the next action is the related action, by displaying a related action image including the related image as the action image corresponding to the next action, the information providing unit presents the related image on the game screen via the related action image such that the action image corresponding to the one action and the related action image differ at least in presence or absence of the related image.

6. The game system of claim 5, wherein the action image is configured to indicate an action in a predetermined duration in the series of actions, and includes a character video that reproduces the action in the predetermined duration through the action of the character and a plurality of still character images corresponding to still images at predetermined intervals in the character video, and
the information providing unit displays the related action image on the game screen such that the related image is included instead of the plurality of still character images.

7. The game system of claim 6, wherein the plurality of still character images includes a characteristic still character image as the still character image corresponding to the characteristic posture of the character in the character video, and is displayed such that a display mode is different between the characteristic still character image and another still character image.

8. A non-transitory computer readable storage medium storing a computer program configured to cause a computer connected to the output device and the detection device to function as each unit of the game system of claim 1.

9. A control method executed by a computer incorporated in a game system that is connected to an output device including a display device that displays a game screen in which an action image showing each action of a series of actions that constitute a dance is presented in order of the series of actions and a detection device that detects a user's action, and provides a timing game that guides each action and execution time of each action through the action image and evaluates the user's action, wherein the control method comprises:
an action specifying procedure that specifies one action of the series of actions and a next action that follows the one action based on sequence data (QD) in which each action of the series of actions and the execution time to execute each action are described in association with each other; and
an information providing procedure that provides the user with related information indicating relevance between the one action and the next action through the output device when the next action is a related action to be executed based on the one action as an action related to the one action.
